(19) United States
(12) Patent Application Publication
(10) Pub. No.: US 2026/0186900 A1
(43) Pub. Date: Jul. 2, 2026

(54) COMPONENT-LEVEL ERROR CONTROL FOR DATA PROTECTION

(71) Applicant: Micron Technology, Inc., Boise, ID (US)

(72) Inventors: Anthony D. Veches, Boise, ID (US); Frank F. Ross, Boise, ID (US); Scott E. Schaefer, Boise, ID (US); Sujeet V. Ayyapureddi, Boise, ID (US); Randall J. Rooney, Boise, ID (US); Navid Lashkarian, Pleasanton, CA (US); Matthew A. Prather, Boise, ID (US)

(21) Appl. No.: 19/420,467

(22) Filed: Dec. 15, 2025

Related U.S. Application Data
(60) Provisional application No. 63/740,085, filed on Dec. 30, 2024.

(51) Int. Cl. G06F 11/10

(52) U.S. Cl. CPC G06F 11/1044

(57) ABSTRACT

Methods, systems, and devices for component level error correction code (ECC) for data protection are described. An ECC component may be added to a memory system that may be configured to perform error correction for data stored within multiple memory dies in the memory system using parity bits from one or more of the memory dies. For example, on-die ECC may disabled at one or more of the memory dies and one or more parity bits previously used for on-die error correction by the one or more memory dies may be transferred from the memory dies to the ECC component for use in the component-level error correction. That is, instead of correcting data at each memory die, the data and one or more parity bits may be transferred to the ECC component and combined for error correction within the ECC component.

### CROSS REFERENCE

The present Application for Patent claims priority to U.S. Patent Application No. 63/740,085 by Veches et al., entitled “COMPONENT-LEVEL ERROR CONTROL FOR DATA PROTECTION,” filed Dec. 30, 2024, which is assigned to the assignee hereof, and which is expressly incorporated by reference in its entirety herein.

### TECHNICAL FIELD

The following relates to one or more systems for memory, including component-level error control for data protection.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports a component level error control for data protection in accordance with examples as disclosed herein.

FIG. 2 shows an example of a system that supports component level error control for data protection in accordance with examples as disclosed herein.

FIG. 3 shows an example of a process flow that supports component level error control for data protection in accordance with examples as disclosed herein.

FIG. 4 shows a block diagram of a memory system that supports component level error control for data protection in accordance with examples as disclosed herein.

FIG. 5 shows a flowchart illustrating a method or methods that support component level error control for data protection in accordance with examples as disclosed herein.

### DETAILED DESCRIPTION

Some memory systems may include multiple memory dies (e.g., memory devices). Each memory die may include one or more memory arrays for storage of data. In some examples, one or more of the memory dies may be configured with on-die error correction capabilities (e.g., on-die error correction code (ECC)) to correct errors when reading and writing data to the die. That is, each of the one or more memory dies may include an on-die error correction component that may perform error detection and correction for data stored at the memory dies.

Although the on-die error correction may detect and correct errors in data stored to the memory die, there may still be errors that occur as data is transferred via a memory channel within the memory system. As such, the data transferred from the memory system to a host system may include errors, in some examples. Additionally, or alternatively, one or more memory dies in the memory system may be reserved for storage of system-level parity information, which may be used to detect and correct errors at a system-level (e.g., errors that occur as data is transferred over the memory channel). The reservation of such memory dies for parity information may reduce storage efficiency. Thus, the combination of on-die error correction and storage of parity for system-level error correction may reduce storage efficiency and increase overhead, in some examples. Additionally, or alternatively, for a host system to perform error correction, additional bits may be exchanged over an interface between the memory system and the host system, which may increase input/output (I/O) overhead and reduce efficiency.

To increase efficiency of a memory system, error control operations may be performed at a component-level. For example, an error control component may be added to the memory system, which may be configured to perform error correction for data stored within multiple memory dies in the memory system using parity bits from one or more of the memory dies. The error control component may be an example of a component that may perform ECC corrections and communicate the corrected data to other components of the memory system. In some examples, the error control component may perform double-bit corrections or other higher-level corrections, and may be located in an registered clock driver (RCD), a buffer, a distributed buffer, a base die, or another component of the memory system. For example, on-die error control may disabled at one or more of the memory dies and one or more parity bits previously used for on-die error correction by the one or more memory dies may be transferred from the memory dies to the error control component for use in the component-level error correction. That is, instead of correcting data on each memory die, the data and one or more parity bits may be transferred to the error control component and combined for error correction within the error control component before being transferred to a host system. By disabling the on-die error correction at one or more of the memory dies and using the parity bits within the error control component for system-level correction, one or more extra memory dies previously reserved for storage of parity information may be removed to reduce a footprint of the memory system, reduce power consumption, and reduce costs overall, among other examples.

In addition to applicability in memory systems as described herein, techniques for component-level error control for data protection may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds, which may decrease processing or latency times, improve response times, or otherwise improve user experience, among other benefits.

In addition to applicability in memory systems and electronic devices described herein, techniques for component-level error control for data protection may be generally implemented to improve security and/or authentication features of various electronic devices and systems. As the use of electronic devices for handling private, user, or other sensitive information has become even more widespread, electronic devices and systems have become the target of increasingly frequent and sophisticated attacks. Further, unauthorized access or modification of data in security-critical devices such as vehicles, healthcare devices, and others may be especially concerning. Implementing the techniques described herein may improve the security of electronic devices and systems by increasing granularity of ECC operations, and may prevent or mitigate unauthorized access to data or other information, incur lower latency costs (e.g., by implementing it at component level), among other benefits.

Features of the disclosure are illustrated and described in the context of systems and architectures. Features of the disclosure are further illustrated and described in the context of process flows and flowcharts.

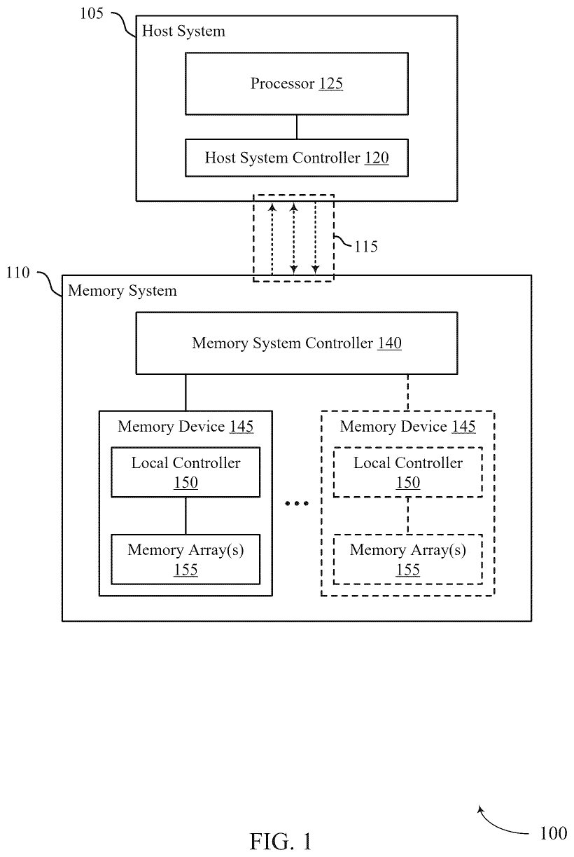

FIG. 1 illustrates an example of a system 100 that supports component level error control for data protection in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

The host system 105 may include one or more components (e.g., circuitry, processing circuitry, one or more processing components) that use memory to execute processes, any one or more of which may be referred to as or be included in a processor 125. The processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. The processor 125 may be an example of a central processing unit (CPU), a graphics processing unit (GPU), a general-purpose GPU (GPGPU), or an SoC or a component thereof, among other examples.

The host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating the memory system 110, such as write commands, read commands, configuration signaling or other operational signaling. In some examples, the host system controller 120, or associated functions described herein, may be implemented by or be part of the processor 125. For example, a host system controller 120 may be hardware, instructions (e.g., software, firmware), or some combination thereof implemented by the processor 125 or other component of the host system 105. In various examples, a host system 105 or a host system controller 120 may be referred to as a host.

The memory system 110 provides physical memory locations (e.g., addresses) that may be used or referenced by the system 100. The memory system 110 may include a memory system controller 140 and one or more memory devices 145 (e.g., memory packages, memory dies, memory chips) operable to store data. The memory system 110 may be configurable for operations with different types of host systems 105, and may respond to commands from the host system 105 (e.g., from a host system controller 120). For example, the memory system 110 (e.g., a memory system controller 140) may receive a write command indicating that the memory system 110 is to store data received from the host system 105, or receive a read command indicating that the memory system 110 is to provide data stored in a memory device 145 to the host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of the memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with the host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 and one or more memory arrays 155. A memory array 155 may be a collection of memory cells (e.g., a two-dimensional array, a three-dimensional array), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

A command/address channel (e.g., a CA channel) may be operable to communicate commands between the host system 105 and the memory system 110, including control information associated with the commands (e.g., address information, configuration information). Commands carried by a command/address channel may include a write command with an address for data to be written to the memory system 110 or a read command with an address of data to be read from the memory system 110.

A clock signal channel may be operable to communicate one or more clock signals between the host system 105 and the memory system 110. Clock signals may oscillate between a high state and a low state, and may support coordination (e.g., in time) between operations of the host system 105 and the memory system 110. In some examples, a clock signal may provide a timing reference for operations of the memory system 110. A clock signal may be referred to as a control clock signal, a command clock signal, or a system clock signal. A system clock signal may be generated by a system clock, which may include one or more hardware components (e.g., oscillators, crystals, logic gates, transistors).

A data channel (e.g., a DQ channel) may be operable to communicate (e.g., bidirectionally) information (e.g., data, control information) between the host system 105 and the memory system 110. For example, a data channel may communicate information from the host system 105 to be written to the memory system 110, or information read from the memory system 110 to the host system 105. In some examples, channels 115 may include one or more error detection code (EDC) channels. An EDC channel may be operable to communicate error detection signals, such as checksums or parity bits, which may accompany information conveyed over a data channel.

The memory system 110 may include multiple memory dies (e.g., the memory devices 145). Each memory device 145 may include one or more memory arrays 155 for storage of data. In some examples, one or more of the memory device 145 may be configured with on-die error correction capabilities (e.g., on-die ECC) to correct errors when reading and writing data to the memory device 145. That is, each of the one or more memory devices 145 may include an on-die error correction component that may perform error detection and correction for data stored at the memory devices 145. Although the on-die error correction may detect and correct errors in data stored to the memory devices 145, there may still be errors that occur as data is transferred via a memory channel (e.g., the channels 115) within the memory system 110 (e.g., a module). As such, the data transferred from the memory system 110 to a host system 105 may include errors, in some examples. Additionally, or alternatively, one or more memory devices 145 in the memory system 110 may be reserved for storage of system-level parity information, which may be used to detect and correct errors at a system-level (e.g., errors that occur as data is transferred over the channels 115). The reservation of such memory devices 145 for parity information may reduce storage efficiency. Thus, the combination of on-die error correction and storage of parity for system-level error correction may reduce storage efficiency and increase overhead, in some examples. Additionally, or alternatively, for a host system to perform error correction, additional bits may be exchanged over an interface between the memory system 110 and the host system 105, which may increase input/output (I/O) overhead and reduce efficiency.

To increase efficiency of the memory system 110, ECC operations may be performed at a component-level. For example, an ECC component may be added to the memory system 110, which may be configured to perform error correction for data stored within multiple memory devices 145 in the memory system 110 using parity bits from one or more of the memory devices 145. For example, on-die ECC may disabled. The ECC component may be an example of a component that may perform ECC corrections and communicate the corrected data to other components of the memory system 110. In some examples, the ECC component may perform double-bit corrections or other higher-level corrections, and may be located in an RCD, a buffer, a distributed buffer, a base die (e.g., a base memory device 145), or another component of the memory system 110. For example, on-die ECC may disabled at one or more of the memory devices 145 and one or more extra bits previously used for on-die error correction by the one or more memory devices 145 may be transferred from the memory devices 145 to the ECC component for use in the component-level error correction. That is, instead of correcting data on each memory device 145, the data and one or more parity bits may be transferred to the ECC component and combined for error correction within the ECC component before being transferred to the host system 105. By disabling the on-die error correction at one or more of the memory devices 145 and using the parity bits within the ECC component for system-level correction, one or more extra memory devices 145 previously reserved for storage of parity information may be removed to reduce a footprint of the memory system 110, reduce power consumption, and reduce costs overall, among other examples.

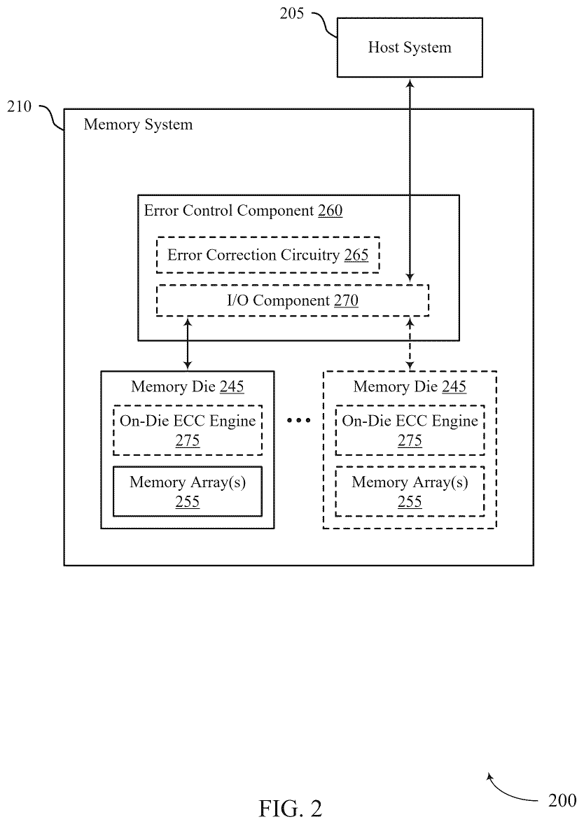

FIG. 2 illustrates an example of an system 200 that supports component level error control for data protection in accordance with examples as disclosed herein. The system 200 represent an example of a system 100 or one or more components thereof. As described herein, the system 200 may include a memory system 210 that supports system-level (e.g., module-level) error correction within an error control component 260 before data is conveyed to a host system 205. The memory system 210 and the host system 205 may be examples of corresponding systems as described herein with reference to FIG. 1.

The memory system 210 may include one or more memory dies 245, which may represent examples of the memory devices 145 described with reference to FIG. 1. Each of the memory dies 245 may include one or more memory arrays 255 configured to store data, parity bits, metadata, or the like. In some examples, each of the memory dies 245 may also include a respective on-die ECC engine 275, which may represent an example of error correction circuitry configured to detect errors, correct errors, or both within the data stored to the memory arrays 255 of the memory die 245. In some other examples, one or more of the memory dies 245 may not include an on-die ECC engine 275.

The memory system 210 may include a memory system controller 160, as described and illustrated with reference to FIG. 1. In this example, the memory system 210 may additionally include the error control component 260. The error control component 260 may be coupled with the memory system controller 160, in some examples, and may be configured to transfer and perform error correction operations on data between the host system 205 and the memory dies 245. All data that enters the memory system 210 from the host system 205 or that is transferred to the host system 205 from the memory system 210 may be transferred through the error control component 260. In some examples, the error control component 260 may include or otherwise be coupled with an I/O component 270 configured to facilitate the transfer of data to and from the memory system 210 via one or more channels, such as the one or more channels 115 described with reference to FIG. 1 (e.g., a link). The error control component 260 may thereby be the point where all data leaving the memory system 210 to the host system 205 (e.g., system on chip (SoC)) passes through.

In some examples, the error control component 260 may be included within a component of the memory system 210. For example, the error control component 260 may be included in a single memory die 245 of the multiple memory dies 245 of the memory system 210, an integrated circuit (IC) of the memory system 210, an independent module of a dual inline memory module (DIMM) of the memory system 210, an RCD of the memory system 210, a buffer of the memory system 210, or a distributed buffer of the memory system 210. Additionally, or alternatively, the error control component 260 may be positioned in a different location relative to the other components of the memory system 210 (e.g., the layout of the memory system 210 may be different than the layout illustrated in FIG. 2).

Techniques described herein provide for a system-level error correction functionality within the error control component 260. That is, the data may be corrected at a system level within the error control component 260 before the data is transferred to the host system 205, which may improve performance, in some examples. For example, transferring the parity bits from one or more of the memory dies 245 configured to store parity information to the error control component 260 may consume less power and overhead than transferring the parity bits off of the memory system 210 to the host system 205. Shipping the parity bits (e.g., extra parity bits) to the host system 205 may increase energy and overhead. Additionally, or alternatively, exposing the parity bits outside of the memory system 210 may pose security risks. Since the error control component 260 is local to the memory system 210, the energy expended to move the extra bits may be less than energy to ship the bits to the host system 205, and security within the memory system 210 may be maintained.

Thus, as described herein, the error control component 260 may receive, in response to a read command, data from one or more of the memory dies 245, as well as one or more parity bits from one or more of the memory dies 245. The error control component 260 may be configured to perform an error detection and correction operation on the data using the parity bits. In some examples, the error control component 260 may include error correction circuitry 265, which may perform error detection and correction operation on the data instead. The error control component 260 may be configured with one or more types of error control capabilities. For example, the error control component 260 may be configured with a first type of error control capability that may enable the error control component 260 to detect or correct multi-bit errors.

The error control component 260 may also be configured with a second type of error control capability that may enable the error control component 260 to detect or correct single-bit errors. The second type of error control capability may be an example of a capability associated with the on-die ECC engines 275. In some examples, the first type of error control capability may be greater (e.g., able to correct a larger quantity of bit errors) than the second type of error control capability. For example, the first type of error control capability may be more complex and may be capable of correcting more errors per codeword than the second type of error control capability.

Some non-limiting examples of error control schemes may include various ECC algorithms (e.g., ECC using single error correcting (SEC) codes, or SEC and double error detecting (SECDED) codes), Reed Solomon error correction, redundant array of independent disks data recovery (RAIDDR), full single device data correction (SDDC) capable algorithms, among other examples. Each error control scheme may be further associated with one or more error control parameters such as a bit quantity, a parity-check matrix (e.g., an H matrix), an error detection type (e.g., adjacent errors, random errors, bit flip errors), and other parameters.

In some examples, the error control component 260 may perform the error detection and correction operations in accordance with one or more different algorithms or techniques. For example, the error control component 260 (e.g., error correction circuitry 265 within the error control component 260) may include one or more logic components configured to support (e.g., execute) ECC, error-detecting code (EDC), other algorithms, or any combination thereof. The error control component 260 (e.g., I/O component 270 within the error control component 260) may send the corrected data to the host system 205 after the error correction is performed. It may be beneficial to have all correction capability in the error control component 260 using all of the parity bits retrieved from the memory dies 245, rather than performing on-die error corrections. In some other examples, such system-level error correction may be performed in addition to one or more on-die error corrections.

In the case that the memory dies 245 may include the on-die ECC engines 275, techniques described herein may provide for one or more of the on-die ECC engines to be turned off or otherwise disabled, such that the extra parity bits within each memory die 245 may be transferred to the error control component 260 to enhance the system-level error correction. In some examples, each memory die 245 may store an indication of whether on-die error correction is enabled or disabled.

In the case that on-die error correction is disabled at one or more of the memory dies 245, or in the case that the memory dies 245 may not include the on-die ECC engines 275, the memory dies 245 may be configured to transfer parity bits stored at the memory dies 245 to the error control component 260. For example, when a read command is received, a memory die 245 may retrieve the requested data and transfer the requested data in addition to one or more of the parity bits to the error control component 260. The error control component 260 may use the first type of error control capability to perform the error detection and correction operations. The first type of error control capability may improve an accuracy and reliability of the system-level error correction. For example, the error control component 260 may be able to detect and correct an increased quantity of errors with the first type of error control capability. In some examples, if the detection capabilities of the error control component 260 are increased, the error control component 260 may detect one or more errors that traditional on-die ECC engines may not be capable of correcting. In such cases, the error control component 260 may send the data to the host system 205.

In some examples, if on-die error correction may be disabled (e.g., or not included at the memory dies 245) and system-level error correction may be enabled, a size of the memory system 210 may be reduced. For example, one or more extra memory dies 245, or components thereof, may be removed from the memory system 210 during manufacture. If, during manufacture of the memory system 210, the memory system 210 is configured to disable on-die error correction or otherwise initiate the transfer of parity bits from the memory dies 245 to the error control component 260 along with data, then the parity bits from each of the memory dies 245 may provide sufficient parity data for the system-level error correction. As such, one or more other memory dies 245 that may have been allocated for parity storage may be removed from the memory system 210, which may reduce a footprint of the module, reduce power consumption, and improve storage capacity, among other examples.

The memory system 210 may thereby support system-level error correction using an aggregation of parity bits from across multiple memory dies 245 within the error control component 260. By aggregating the error correction at the system level within the error control component 260, the memory system 210 may improve performance and reliability of the error correction while reducing power consumption and overhead via a link between the host system 205 and the memory system 210.

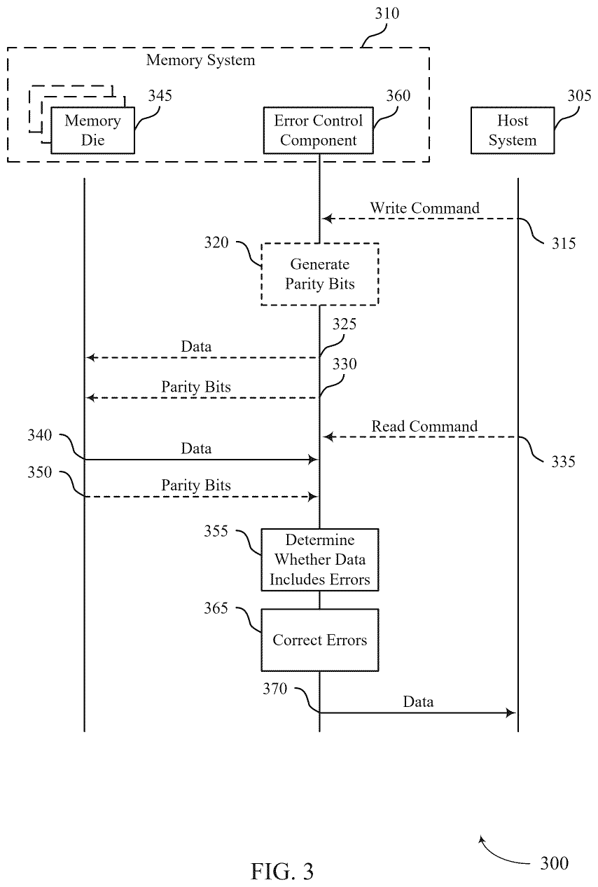

FIG. 3 shows an example of a process flow 300 that supports component level error control for data protection in accordance with examples as disclosed herein. The operations of process flow 300 may be performed by a memory system or one or more controllers associated with a memory system as described herein. For example, the process flow 300 may illustrate exchanges of data and metadata between one or more memory dies 345 and an error control component 360 within a memory system 310, and between the memory system 310 and a host system 305, which may represent examples of corresponding systems and dies as described with reference to FIGS. 1 and 2. In this example, the error control component 360 may include error correction capabilities for correcting errors at the system-level prior to transferring data to the host system 305.

At 315, the host system 305 may transmit a write command to the memory system 310 via a link (e.g., one or more channels) between the host system 305 and the memory system 310. The write command and the data associated with the write command may be received by one or more components within the memory system 310, including, in some examples, the error control component 360, or other components. For example, in the case that the error control component 360 may be located in a single memory die 345 of the multiple memory dies, an IC of the memory system 310, a DIMM of the memory system 310, an RCD of the memory system 310, a buffer of the memory system 310, or a distributed buffer of the memory system 310, a controller of the respective component or the error control component 360 may receive the write command. The memory system 310 (e.g., a memory system controller, the error control component 360, or other component) may initiate an error correction operation on the data based on receiving the write command.

At 320, as described herein, the error control component 360 of the memory system 310 (e.g., error correction circuitry within the error control component 360) may generate, based on the data indicated via the write command, one or more parity bits (e.g., one or more error correction codes) associated with the data. The error control component 360 may generate the parity bits based on a mode of the error control component 360 indicating that system-level error correction is supported, in some examples.

At 325, the error control component 360 may transfer the data indicated via the write command to one or more memory dies 345 within the memory system 310. Based on generating the parity bits, the memory system 310 may store the data one or more target addresses of the memory dies 345. At 330, in some examples, the error control component 360 may also transmit one or more of the parity bits generated at 320 to the one or more memory dies 345 for storage with the data. Additionally, or alternatively, the error control component 360 may store the parity bits at the error control component 360, in some examples.

At 335, the host system 305 may transmit a read command to the memory system 310 via the link between the host system 305 and the memory system 310. The read command may indicate one or more addresses associated with the data stored at 325. The host system 305 may use the read command to request to read the previously stored data.

At 340, in response to the read command, the memory system 310 may retrieve the requested data from one or more memory dies 345. The memory dies 345 may transfer the data to the error control component 360. If on-die error correction is enabled, the on-die error correction circuitry at the one or more memory dies 345 may correct one or more errors in the data before transferring the data to the error control component 360. If on-die error correction is disabled, the one or more memory dies 345 may transfer the data and one or more parity bits along with the data. The one or more parity bits may be allocated for on-die error correction, and may be transferred to the error control component 360 for use in the system-level error correction, as described with reference to FIG. 2.

At 350, in the case that the one or more parity bits were previously stored at the memory dies 345, the memory dies 345 may transfer the one or more parity bits associated with the data back to the error control component 360 in response to the read command.

At 355, the error control component 360 may receive the data associated with one or more memory dies 345 of the memory system 310 and may determine whether the data may include one or more errors. For example, the error control component 360 may generate one or more second parity bits based on the received data. In some examples, the error correction circuitry within the error control component 360 may generate the second parity bits using a similar algorithm or technique as used to generate the parity bits at 320. The error control component 360 may determine whether the data includes one or more errors based on comparing the second parity bits and the one or more parity bits previously generated at 320 and stored at the memory dies 325. The error control component 360 may, for example, compare the parity bits with the second parity bits to determine if they are the same or at least within a threshold level of similarity. If the parity bits are different or sufficiently different from one another, the error control component 360 may determine that there is at least one error within the data (e.g., may detect an error). If the parity bits are similar or the same, the error control component 360 may determine that there is not an error within the data.

At 365, the error control component 360 may correct one or more of the errors in the data, if any are detected at 355. For example, the error control component 360 (e.g., error correction circuitry within the error control component 360) may correct one or more errors in the data according to a first type of error control capability that may be greater (e.g., more efficient, more effective) than a second type of error control capability associated with on-die ECC engines. In some other examples, the error control component 360 may correct one or more errors in the data according to the second type of error control capability. The first type of error control capability may be configured to detect or correct multi-bit errors, whereas the second type of error control capability may be configured to detect or correct single-bit errors. In some examples, the error control component 360 may use one or more algorithms and corresponding logic gates to correct the errors (e.g., ECC, EDC, hamming codes, Reed-Solomon codes, any other error correction codes). The error control component 360 may perform the error detection and correction using one or more parity bits. In some examples, the parity bits may represent examples of one or more additional bits that are separate from the data (e.g., different from, do not include the data).

At 370, the error control component 360 may transfer, via an interface between the error control component 360 and the host system 305 (e.g., the one or more channels 115), the data to the host system 305. The error control component 360 may transfer the data based on detecting and/or correcting the one or more errors in the data and as part of the read operation by the host system 305 (e.g., in response to the read command). The error control component 360 may transfer the data without correcting errors based on determining that the data may not include one or more (e.g., any) errors.

The memory system 310 described herein may thereby support system-level error correction within an error control component 360 may transfer the data, which may improve reliability and performance of a link between the host system 305 and the memory system 310, among other examples.

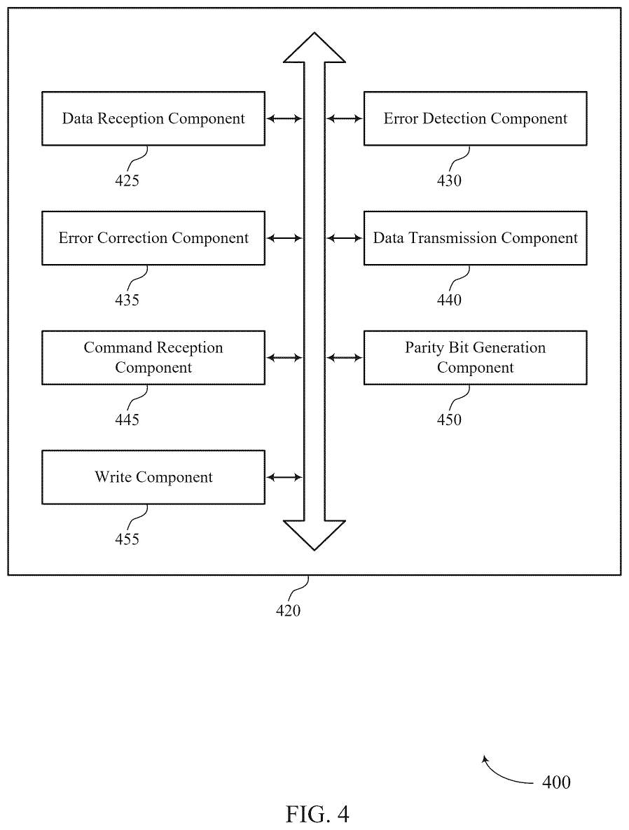

FIG. 4 shows a block diagram 400 of a memory system 420 that supports component level error control for data protection in accordance with examples as disclosed herein. The memory system 420 may be an example of aspects of a memory system as described with reference to FIGS. 1 through 3. The memory system 420, or various components thereof, may be an example of means for performing various aspects of component level error control for data protection as described herein. For example, the memory system 420 may include a data reception component 425, an error detection component 430, an error correction component 435, a data transmission component 440, a command reception component 445, a parity bit generation component 450, a write component 455, or any combination thereof. Each of these components, or components of subcomponents thereof (e.g., one or more processors, one or more memories), may communicate, directly or indirectly, with one another (e.g., via one or more buses).

The data reception component 425 may be configured as or otherwise support a means for receiving, at an error control component coupled with each memory die of a plurality of memory dies of the memory system via one or more channels, data associated with a memory die of the plurality of memory dies, where the error control component includes a first type of error control capability that is greater than a second type of error control capability that is configured to detect or correct single-bit errors. The error detection component 430 may be configured as or otherwise support a means for determining, at the error control component, whether the data includes one or more errors based at least in part on receiving the data. The error correction component 435 may be configured as or otherwise support a means for correcting, at the error control component, the data using the first type of error control capability or the second type of error control capability based at least in part on determining that the data includes one or more errors. The data transmission component 440 may be configured as or otherwise support a means for transmitting the corrected data to a host system based at least in part on correcting the data using the first type of error control capability or the second type of error control capability.

In some examples, the command reception component 445 may be configured as or otherwise support a means for receiving a read command for the data associated with the memory die, where the corrected data is transmitted to the host system as part of a read operation associated with the read command.

In some examples, the command reception component 445 may be configured as or otherwise support a means for receiving a write command including the data associated with the memory die. In some examples, the parity bit generation component 450 may be configured as or otherwise support a means for generating, by the error control component, one or more parity bits associated with the data based at least in part on receiving the write command. In some examples, the write component 455 may be configured as or otherwise support a means for writing the data to the memory die based at least in part on generating the one or more parity bits.

In some examples, at least one parity bit is written with the data to the memory die.

In some examples, to support correcting the data using the first type of error control capability, the error correction component 435 may be configured as or otherwise support a means for correcting the one or more errors in accordance with one or more parity bits associated with the data.

In some examples, the first type of error control capability is configured to detect or correct multi-bit errors.

In some examples, the error control component is located at a single memory die of the plurality of memory dies, an IC of the memory system, a DIMM of the memory system, an RCD of the memory system, a buffer of the memory system, or a distributed buffer of the memory system.

In some examples, the data transmission component 440 may be configured as or otherwise support a means for transmitting the data to the host system based at least in part on determining that the data does not include one or more errors.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

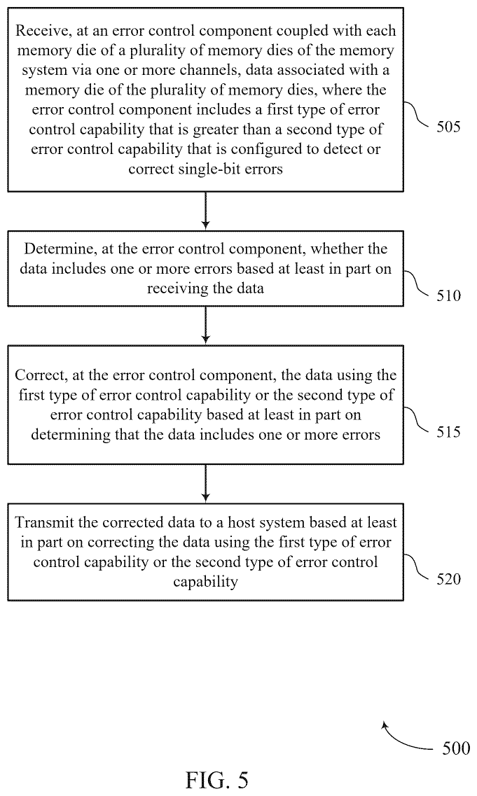

FIG. 5 shows a flowchart illustrating a method 500 that supports component level error control for data protection in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving, at an error control component coupled with each memory die of a plurality of memory dies of the memory system via one or more channels, data associated with a memory die of the plurality of memory dies, where the error control component includes a first type of error control capability that is greater than a second type of error control capability that is configured to detect or correct single-bit errors. In some examples, aspects of the operations of 505 may be performed by a data reception component 425 as described with reference to FIG. 4.

At 510, the method may include determining, at the error control component, whether the data includes one or more errors based at least in part on receiving the data. In some examples, aspects of the operations of 510 may be performed by an error detection component 430 as described with reference to FIG. 4.

At 515, the method may include correcting, at the error control component, the data using the first type of error control capability or the second type of error control capability based at least in part on determining that the data includes one or more errors. In some examples, aspects of the operations of 515 may be performed by an error correction component 435 as described with reference to FIG. 4.

At 520, the method may include transmitting the corrected data to a host system based at least in part on correcting the data using the first type of error control capability or the second type of error control capability. In some examples, aspects of the operations of 520 may be performed by a data transmission component 440 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving, at an error control component coupled with each memory die of a plurality of memory dies of the memory system via one or more channels, data associated with a memory die of the plurality of memory dies, where the error control component includes a first type of error control capability that is greater than a second type of error control capability that is configured to detect or correct single-bit errors; determining, at the error control component, whether the data includes one or more errors based at least in part on receiving the data; correcting, at the error control component, the data using the first type of error control capability or the second type of error control capability based at least in part on determining that the data includes one or more errors; and transmitting the corrected data to a host system based at least in part on correcting the data using the first type of error control capability or the second type of error control capability.

Aspect 2: The method, apparatus, or non-transitory computer-readable medium of aspect 1, further including operations, features, circuitry, logic, means, or instructions, or any combination thereof for receiving a read command for the data associated with the memory die, where the corrected data is transmitted to the host system as part of a read operation associated with the read command.

Aspect 3: The method, apparatus, or non-transitory computer-readable medium of any of aspects 1 through 2, further including operations, features, circuitry, logic, means, or instructions, or any combination thereof for receiving a write command including the data associated with the memory die; generating, by the error control component, one or more parity bits associated with the data based at least in part on receiving the write command; and writing the data to the memory die based at least in part on generating the one or more parity bits.

Aspect 4: The method, apparatus, or non-transitory computer-readable medium of aspect 3, where at least one parity bit is written with the data to the memory die.

Aspect 5: The method, apparatus, or non-transitory computer-readable medium of any of aspects 1 through 4, where correcting the data using the first type of error control capability includes operations, features, circuitry, logic, means, or instructions, or any combination thereof for correcting the one or more errors in accordance with one or more parity bits associated with the data.

Aspect 6: The method, apparatus, or non-transitory computer-readable medium of any of aspects 1 through 5, where the first type of error control capability is configured to detect or correct multi-bit errors.

Aspect 7: The method, apparatus, or non-transitory computer-readable medium of any of aspects 1 through 6, where the error control component is located at a single memory die of the plurality of memory dies, an IC of the memory system, a DIMM of the memory system, an RCD of the memory system, a buffer of the memory system, or a distributed buffer of the memory system.

Aspect 8: The method, apparatus, or non-transitory computer-readable medium of any of aspects 1 through 7, further including operations, features, circuitry, logic, means, or instructions, or any combination thereof for transmitting the data to the host system based at least in part on determining that the data does not include one or more errors.

It should be noted that the aspects described herein describe possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 9: A memory system, including: a plurality of memory dies; and an error control component coupled with each memory die of the plurality of memory dies via one or more channels, the error control component configured with a first type of error control capability that is greater than a second type of error control capability that is configured to detect or correct single-bit errors, where the error control component is configured to: receive data associated with a memory die of the plurality of memory dies; determine whether the data includes one or more errors based at least in part on receiving the data; correct the data using the first type of error control capability or the second type of error control capability based at least in part on determining that the data includes one or more errors; and transmit the corrected data to a host system based at least in part on correcting the data using the first type of error control capability or the second type of error control capability.

Aspect 10: The apparatus of aspect 9, where the error control component is configured to: receive a read command for the data associated with the memory die, where the corrected data is transmitted to the host system as part of a read operation associated with the read command.

Aspect 11: The memory system of aspect 9 through 10, where the error control component is configured at a single memory die of the plurality of memory dies, an IC of the memory system, an independent module of a DIMM of the memory system, an RCD of the memory system, a buffer of the memory system, or a distributed buffer of the memory system.

Aspect 12: The memory system of any of aspects 9 through 11, where the error control component is configured to: generate one or more parity bits associated with the data based at least in part on a write command, where the data is written to the memory die based at least in part on the error control component generating the one or more parity bits.

Aspect 13: The memory system of aspect 12, where at least one parity bit is written with the data to the memory die.

Aspect 14: The memory system of any of aspects 9 through 13, where the error control component is configured to: correct the one or more errors in accordance with one or more parity bits associated with the data.

Aspect 15: The memory system of any of aspects 9 through 14, where the first type of error control capability is configured to detect or correct multi-bit errors.

Aspect 16: The apparatus of any of aspects 9 through 15, where the error control component is configured to: transmit the data to the host system based at least in part on determining that the data does not include one or more errors.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorous, boron, or arsenic.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
a plurality of memory dies; and
an error control component coupled with each memory die of the plurality of memory dies via one or more channels, the error control component configured with a first type of error control capability that is greater than a second type of error control capability that is configured to detect or correct single-bit errors, wherein the error control component is configured to:
receive data associated with a memory die of the plurality of memory dies;
determine whether the data comprises one or more errors based at least in part on receiving the data;
correct the data using the first type of error control capability or the second type of error control capability based at least in part on determining that the data comprises one or more errors; and
transmit the corrected data to a host system based at least in part on correcting the data using the first type of error control capability or the second type of error control capability.

2. The method of claim 1, wherein the error control component is configured to:
receive a read command for the data associated with the memory die, wherein the corrected data is transmitted to the host system as part of a read operation associated with the read command.

3. The memory system of claim 1, wherein the error control component is configured at a single memory die of the plurality of memory dies, an integrated circuit (IC) of the memory system, an independent module of a dual inline memory module (DIMM) of the memory system, a register clock driver (RCD) of the memory system, a buffer of the memory system, or a distributed buffer of the memory system.

4. The memory system of claim 1, wherein the error control component is configured to:
generate one or more parity bits associated with the data based at least in part on a write command, wherein the data is written to the memory die based at least in part on the error control component generating the one or more parity bits.

5. The memory system of claim 4, wherein at least one parity bit is written with the data to the memory die.

6. The memory system of claim 1, wherein the error control component is configured to:
correct the one or more errors in accordance with one or more parity bits associated with the data.

7. The memory system of claim 1, wherein the first type of error control capability is configured to detect or correct multi-bit errors.

8. The method of claim 1, wherein the error control component is configured to:
transmit the data to the host system based at least in part on determining that the data does not comprise one or more errors.

9. A method by a memory system, comprising:
receiving, at an error control component coupled with each memory die of a plurality of memory dies of the memory system via one or more channels, data associated with a memory die of the plurality of memory dies, wherein the error control component comprises a first type of error control capability that is greater than a second type of error control capability that is configured to detect or correct single-bit errors;
determining, at the error control component, whether the data comprises one or more errors based at least in part on receiving the data;
correcting, at the error control component, the data using the first type of error control capability or the second type of error control capability based at least in part on determining that the data comprises one or more errors; and
transmitting the corrected data to a host system based at least in part on correcting the data using the first type of error control capability or the second type of error control capability.

10. The method of claim 9, further comprising:
receiving a read command for the data associated with the memory die, wherein the corrected data is transmitted to the host system as part of a read operation associated with the read command.

11. The method of claim 9, further comprising:
receiving a write command comprising the data associated with the memory die;
generating, by the error control component, one or more parity bits associated with the data based at least in part on receiving the write command; and
writing the data to the memory die based at least in part on generating the one or more parity bits.

12. The method of claim 11, wherein at least one parity bit is written with the data to the memory die.

13. The method of claim 9, wherein correcting the data using the first type of error control capability comprises:
correcting the one or more errors in accordance with one or more parity bits associated with the data.

14. The method of claim 9, wherein the first type of error control capability is configured to detect or correct multi-bit errors.

15. The method of claim 9, wherein the error control component is located at a single memory die of the plurality of memory dies, an integrated circuit (IC) of the memory system, a dual inline memory module (DIMM) of the memory system, a register clock driver (RCD) of the memory system, a buffer of the memory system, or a distributed buffer of the memory system.

16. The method of claim 9, further comprising:
transmitting the data to the host system based at least in part on determining that the data does not comprise one or more errors.

17. A non-transitory computer-readable medium storing code, the code comprising instructions executable by one or more processors to:
receive, at an error control component coupled with each memory die of a plurality of memory dies of the memory system via one or more channels, data associated with a memory die of the plurality of memory dies, wherein the error control component comprises a first type of error control capability that is greater than a second type of error control capability that is configured to detect or correct single-bit errors;
determine, at the error control component, whether the data comprises one or more errors based at least in part on receiving the data;
correct, at the error control component, the data using the first type of error control capability or the second type of error control capability based at least in part on determining that the data comprises one or more errors; and
transmit the corrected data to a host system based at least in part on correcting the data using the first type of error control capability or the second type of error control capability.

18. The non-transitory computer-readable medium of claim 17, wherein the instructions are further executable by the one or more processors to:
receive a read command for the data associated with the memory die, wherein the corrected data is transmitted to the host system as part of a read operation associated with the read command.

19. The non-transitory computer-readable medium of claim 17, wherein the instructions are further executable by the one or more processors to:
receive a write command comprising the data associated with the memory die;
generate, by the error control component, one or more parity bits associated with the data based at least in part on receiving the write command; and
write the data to the memory die based at least in part on generating the one or more parity bits.

20. The non-transitory computer-readable medium of claim 19, wherein at least one parity bit is written with the data to the memory die.

21. The non-transitory computer-readable medium of claim 17, wherein the instructions to correct the data using the first type of error control capability are executable by the one or more processors to:
correct the one or more errors in accordance with one or more parity bits associated with the data.

22. The non-transitory computer-readable medium of claim 17, wherein:
the first type of error control capability is configured to detect or correct multi-bit errors.

23. The non-transitory computer-readable medium of claim 17, wherein the error control component is located at a single memory die of the plurality of memory dies, an integrated circuit (IC) of the memory system, a dual inline memory module (DIMM) of the memory system, a register clock driver (RCD) of the memory system, a buffer of the memory system, or a distributed buffer of the memory system.

24. The non-transitory computer-readable medium of claim 17, wherein the instructions are further executable by the one or more processors to:
transmit the data to the host system based at least in part on determining that the data does not comprise one or more errors.
